(19) United States
(12) Patent Application Publication
(10) Pub. No.: US 2013/0335636 A1
(43) Pub. Date: Dec. 19, 2013

(54) METHOD FOR OUTPUTTING IMAGE AND ELECTRONIC DEVICE FOR USING THE SAME

(71) Applicant: Sheng-Ta Hsieh, New Taipei City (TW)

(72) Inventor: Sheng-Ta Hsieh, New Taipei City (TW)

(73) Assignee: WISTRON CORPORATION, New Taipei City (TW)

(21) Appl. No.: 13/589,192

(22) Filed: Aug. 20, 2012

(30) Foreign Application Priority Data
Jun. 19, 2012 (TW) 101121908

(51) Int. Cl. H04N 5/268

(52) U.S. Cl. 348/705; 348/E05.057

(57) ABSTRACT

A method for outputting images adopted by an electronic device having a display unit and at least one connection port is provided. The method comprises displaying options of available external devices, wherein each of the options of the available external devices respectively corresponds to an external display device connected to the electronic device through the corresponding connection port. A selection signal is received to select one of the options of the available external devices. An image of one of the image frames displayed on the display unit is outputted to the external display device corresponding to the selected option of the available external device. When a first task corresponding to the output image is continuously executed either in the background or in the foreground, the image is continuously outputted to the selected external display device. The image outputted from the electronic device is displayed on the external display device.

### CROSS-REFERENCE TO RELATED APPLICATION

This application claims the priority benefit of Taiwan application serial no. 101121908, filed on Jun. 19, 2012. The entirety of the above-mentioned patent application is hereby incorporated by reference herein and made a part of this specification.

### BACKGROUND OF THE INVENTION

1. Field of Invention

The present invention relates to a method of outputting an image and an electronic device. More particularly, the present invention relates to a method of outputting a single image frame and an electronic device.

2. Description of Related Art

Generally, the electronic device having connection ports can output image data to the big screen through the connection port so as to share with others. The electronic devices such as mobile phone, tablet personal computer and notebook can output the content of report to the monitor, television or projector by using the high definition multimedia interface (HDMI), the mobile high-definition link (MHL), the video graphic array out (VGA out), the television out (TV out) or the super video (S-video also known as the separated video).

Currently, the image output software in the market is to output the entire image displayed by the display unit of the electronic device to another external display device or to output the content of the report in a form of extension desktop. Hence, the output image sometimes includes irrelevant content which is the specific content and cannot be shared because of the individual privacy. Moreover, when the user share the image to the external display device, it is impossible to execute other task without affect the image output status.

### SUMMARY OF THE INVENTION

The present invention provides an image output method capable of outputting a single and assigned image frame while a display unit of an electronic device displays multiple image frames so that the goal of protecting individual privacy can be achieved.

The invention provides an electronic device capable of executing multiple tasks at the time a single image frame is outputted so that the utilization efficiency can be increased.

The invention provides a method of outputting an image output method for an electronic device having a display unit and at least one connection port. The mage output method comprises the display unit displays at least an available external device option, wherein each of the available external device options respectively corresponds to an external display device connected to the electronic device through the corresponding connection port. A selection signal is received to select one of the available external device options. An image of one of at least an image frame displayed on the display unit is outputted to the external display device corresponding to the selected available external device option, wherein when a first task corresponding to the output image is continuously executed either in a background or in a foreground of the electronic device, the image is continuously outputted to the external display device corresponding to the selected available external device option. The image outputted from the electronic device is displayed on the external display device.

According to one embodiment of the present invention, the image output method further comprises when the electronic device opens a second task to show the image frame corresponding to the second task on the display unit and the electronic device continuously executes the first task, the electronic device continuously outputting the image of the image frame corresponding to the first task to the external display device corresponding to the selected available external device option.

According to one embodiment of the present invention, the image output method further comprises when the display unit is switched to show the image frame corresponding to a third task from showing the image frame corresponding to the first task and the electronic device continuously executes the first task, the electronic device continuously outputs the image of the image frame corresponding to the first task to the external display device corresponding to the selected available external device option.

According to one embodiment of the present invention, the image output method further comprises recording a task-connection port relationship between the first task and the connection port for outputting the image of the image frame corresponding to the first task to the external display device corresponding to the selected available external device option.

According to one embodiment of the present invention, the step of outputting the image of one of the image frames displayed on the display unit to the external display device corresponding to the selected available external device option comprises: automatically detecting an external device resolution of the external display device corresponding to the selected available external device option. According to the external device resolution, an external display image buffer from a system memory of the electronic device is allocated to map the external display device corresponding to the selected available external device option. According to the external device resolution, the image of the image frame is scaled. The scaled image of the image frame is mapped to the external display image buffer and the scaled image of the image frame in the external display image buffer is transmitted to the external display device corresponding to the selected available external device option.

According to one embodiment of the present invention, the step of scaling the image of the image frame is executed at the background of the electronic device.

According to one embodiment of the present invention, the step of scaling the image of the image frame comprises scaling the image to be a full-screen image.

According to one embodiment of the present invention, before the step of transmitting the scaled image of the image frame in the external display image buffer to the external display device corresponding to the selected available external device option, the image output method further comprises setting a set of parameters of the external display device corresponding to the selected available external device option.

According to one embodiment of the present invention, after the step of receiving the selection signal and before the step of outputting the image to the external display device corresponding to the selected available external device option, the image output method further comprises determining whether the external display device corresponding to the selected available external device option has displayed the image of the image frame corresponding to a fourth task and when the external display device corresponding to the selected available external device option has displayed the image of the image frame corresponding to the fourth task, the electronic device stops outputting the image of the image frame corresponding to the fourth task to the external display device corresponding to the selected available external device option.

According to one embodiment of the present invention, before the display unit displays the available external device options, the image output method further comprises detecting the connection ports of the electronic device to determine a connection status of the electronic device connecting to at least one of the external display devices, wherein the display unit displays the available external device options according to the connection status.

The method further provides an electronic device comprising a display unit, at least a connection port, a storage device and a central processing unit. The storage device stores a computer readable and writeable program. The central processing unit is coupled to the display unit, the connection ports and the storage device. The central processing unit executes a plurality instructions of computer readable and writeable program. The instructions comprises displaying at least an available external device option on the display unit, wherein each of the available external device options respectively corresponds an external display device connected to the electronic device through the corresponding connection port. A selection signal is received to select one of the available external device options. An image of one of at least an image frame displayed on the display unit is outputted to the external display device corresponding to the selected available external device option, wherein when a first task corresponding to the output image is continuously executed either in a background or in a foreground of the electronic device, the image is continuously outputted to the external display device corresponding to the selected available external device option. The image outputted from the electronic device is displayed on the external display device.

According to one embodiment of the present invention, the instructions further comprise: opening a second task to show the image frame corresponding to the second task on the display unit while the first task corresponding to the outputted image is continuously executed and the electronic device continuously outputting the image of the image frame corresponding to the first task to the external display device corresponding to the selected available device option.

According to one embodiment of the present invention, the instructions further comprises: the display unit switching to show the image frame corresponding to a third task from showing the image frame corresponding to the first task while the first task corresponding to the outputted image is continuously executed and the electronic device continuously outputting the image of the image frame corresponding to the first task to the external display device corresponding to the selected available device option.

According to one embodiment of the present invention, the instructions further comprises: recording a task-connection port relationship between the first task and the connection port for outputting the image of the image frame corresponding to the first task to the external display device corresponding to the selected available external device option and storing the task-connection port relationship in the storage device.

According to one embodiment of the present invention, the electronic device further comprises a system memory, and the instruction of outputting the image of one of the image frames displayed on the display unit to the external display device corresponding to the selected available external device option comprises automatically detecting an external device resolution of the external display device corresponding to the selected available external device option. According to the external device resolution, an external display image buffer from a system memory of the electronic device is allocated to map the external display device corresponding to the selected available external device option. According to the external device resolution, the image of the image frame is scaled. The scaled image of the image frame is mapped to the external display image buffer and the scaled image of the image frame in the external display image buffer is transmitted to the external display device corresponding to the selected available external device option.

According to one embodiment of the present invention, the instruction of scaling the image of the image frame is executed at the background of the electronic device.

According to one embodiment of the present invention, the image of the image frame is scaled to be a full-screen image.

According to one embodiment of the present invention, before the instruction of transmitting the scaled image of the image frame in the external display image buffer to the external display device corresponding to the selected available external device option, the instructions further comprise setting a set of parameters of the external display device corresponding to the selected available external device option.

According to one embodiment of the present invention, after the instruction of receiving the selection signal and before the instruction of outputting the image to the external display device corresponding to the selected available external device option, the instructions further comprises: determining whether the external display device corresponding to the selected available external device option has displayed the image of the image frame corresponding to a fourth task and when the external display device corresponding to the selected available external device option has displayed the image of the image frame corresponding to the fourth task, stopping outputting the image of the image frame corresponding to the fourth task to the external display device corresponding to the selected available external device option.

According to one embodiment of the present invention, before the display unit displays the available external device options, the instructions further comprise detecting the connection ports of the electronic device to determine a connection status of the electronic device connecting to at least one of the external display devices, and the display unit displays the available external device options according to the connection status.

In the present invention, the electronic device launches the image output program embedded in a specific image frame to execute the image output method of the present invention so as to output the image of the specific image frame. Since the external device options are embedded in the tool list of the image frame at the time the image output program embedded in the specific image frame is launched, only the image of the single image frame can be outputted by executing the image output program of the specific image frame no matter the image frame is displayed by executing what kind of task. That is, not all of the frame shown by the display unit is outputted. Thus, the user can only output the image of the image frame which the user is willing to output or share with others so as to achieve the efficiency for protecting the individual privacy. Moreover, the user can open a plurality of image frames at the same time and only output image of the selected image frame. Therefore, at the time the image of the single image frame is outputted, the electronic device can also executes other tasks to improve the utilization efficiency.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart showing an image output method according to one embodiment of the present invention.

FIG. 2 is a flow chart showing the step of determining the displaying status of the external display device in the image output method according to one embodiment of the present invention.

FIG. 3 is a task-connection port relationship table according to one embodiment of the present invention.

FIG. 4 is a flow chart showing the step of outputting an image to the external display device in the image output method according to one embodiment of the present invention.

FIG. 5 is a schematic diagram showing an electronic device according to one embodiment of the present invention.

### DESCRIPTION OF THE PREFERRED EMBODIMENTS

In the present invention, after the target external display device for displaying the output image is selected, only one specific image frame of the several image frames displayed on the display unit of the near end terminal is outputted to the selected target external display unit. It should be noticed that no matter the image frame corresponding to the output image is expanded on the display unit or is minimized (that is, the task corresponding to the image frame is executed in the foreground or in the background), the image of the specific image frame is continuously outputted to the target external display device as long as the task corresponding to the specific image frame is continuously executed (that is the execution of the corresponding task is not terminated). In the following paragraphs, several exemplary embodiments are introduced accompanied with drawings to describe the image output method and the electronic device executing the image output method of the present invention.

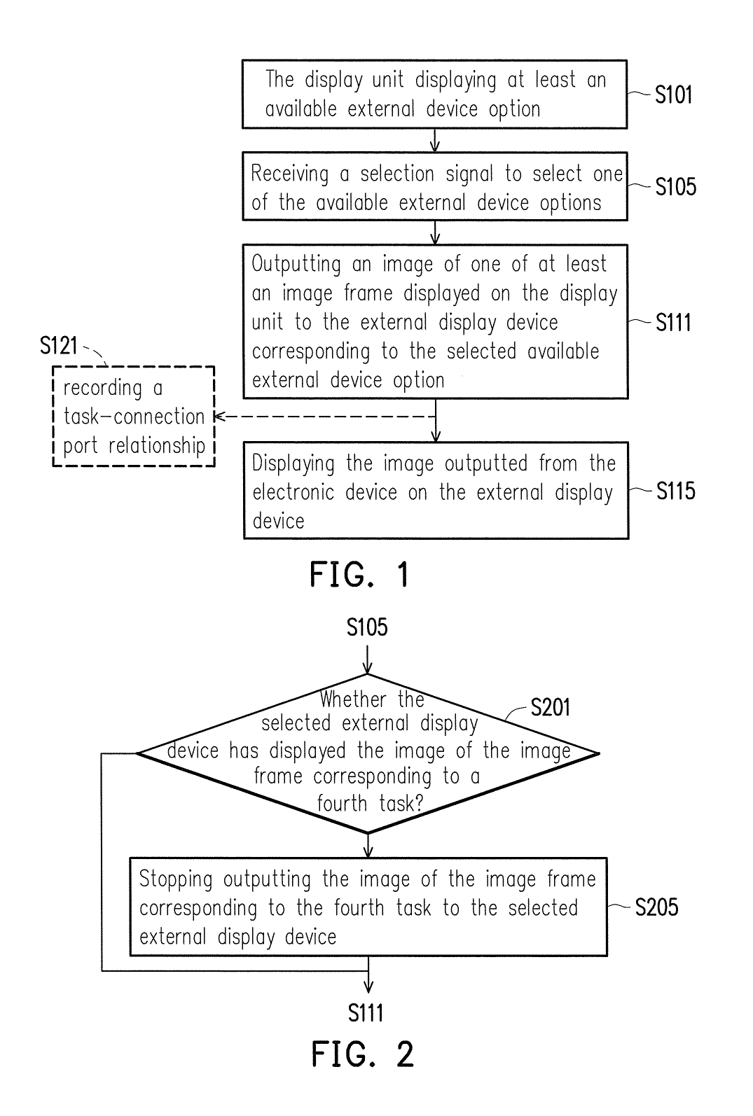

FIG. 1 is a flow chart showing an image output method according to one embodiment of the present invention. In the present embodiment, an electronic device is used to execute an image output method of the present invention. The electronic device comprises a display unit and at least one connection port. The electronic device can be, for example, a personal computer, a tablet personal computer, a notebook, a mobile phone, a smart phone or the electronic device capable of outputting images to the external display device. The connection port can be, for example, a high definition multimedia interface (HDMI) connection port, a mobile high-definition link (MHL) connection port, a video graphic array out (VGA out) connection port, a television out (TV out) connection port or a super video (S-video which is also known as the separated video) connection port.

As shown in FIG. 1, in the step S101, at least one external device option is displayed on the display unit. Each of the external device options corresponds to an external display device connected to the electronic device through the corresponding connection port.

In one embodiment, when the electronic device launches an image output program embedded in a specific image frame to execute the image output method of the present invention so as to output the image of the specific image frame, the electronic device detects the connection ports thereof in advance to ensure that a connection status of the electronic device connecting to at least one external display device. Then, according to the connection status obtained by detecting the connection port, the available external device options are listed. In another embodiment, by the application interface of the operating system executed by the electronic device, the available external device options are embedded into the tool list of each of the opened or later opened image frames on the display unit. In the other embodiment, the displaying form of the available external device options can be that, for example, all of the external device options are displayed and the portion of the external device options respectively corresponding to the external display devices which are ensured to be connected to the electronic device through the corresponding connection ports according to the detection of the connection statuses are highlighted to remind the user that these external device options are the available external device options. Further, the other external device options which are not highlighted are regarded as the unavailable external device options.

Thereafter, in the step S105, the electronic device receives a selection signal to select one of the available external device options. Then, in the step S111, an image of one of the image frames displayed on the display unit (i.e. the image of the specific image frame) is outputted to the external display device corresponding to the selected available external device option (i.e. the selected external display device or the selected target external display device). The image frame can be, for example, a window frame or an execution frame of a single program. It should be noticed that the image frame corresponding to the aforementioned outputted image can be, for example, opened and displayed on the display unit before or after the electronic device launches the image output program embedded in the specific image frame to execute the image output method of the present invention. In other words, the task corresponding to the image frame which corresponds to the aforementioned outputted image is executed by the electronic device and the image frame corresponding to the executed task is displayed on the display unit before or after the image output method of the present invention is executed.

Moreover, when the image of the specific image frame to be outputted is determined and the target external display device is selected, the image of the specific image frame, but not the image of all objects displayed on the display unit, is individually outputted to the target external display device. Moreover, as long as the electronic device continuously executes the task corresponding to the output image of the image frame, the electronic device keeps on outputting the image of the image frame to the selected external display device (i.e. the selected target external display device). More specifically, no matter the electronic device executes a first task corresponding to the outputted image in a foreground or in a background, the electronic device continuously outputs the image corresponding to the first task to the external display device corresponding to the selected available external device as long as the first task is continuously executed.

In one embodiment, when the electronic device starts to run a second task and an image frame corresponding to the second task is displayed on the display unit at the time the electronic device still runs the first task, the electronic device keeps on outputting the image of the image frame corresponding to the first task to the external display device corresponding to the selected available external device option. That is, even another image frame is opened by executing the second task and is displayed on the display unit of the near end electronic device, the image of the image frame corresponding to the first task is still continuously outputted to the selected external display device as the electronic device keeps on running the first task. In other words, even though the image frame corresponding to the first task is minimized on the display unit (that is the image frame is scaled down to be the minimum size) or is expanded but entirely or partially covered by the image frame corresponding to the second task, the image of the image frame corresponding to the first task is still continuously outputted to the selected external display device as the electronic device keeps on running the first task. Hence, the user can perform multiple tasks on the near end electronic device without affecting the image output status of outputting image to the selected external display device.

In another embodiment, when the display unit is switched to show an image frame corresponding to the third task from showing the image frame corresponding to the first task and the electronic device continuously executes the first task, the electronic device continuously outputs the image of the image frame corresponding to the first task to the external display device corresponding to the selected available external device option. That is, no matter what kind of the major displayed image frame on the display unit of the near end electronic is, the electronic device continuously output the image of the image frame corresponding to the first task to the selected external display device as long as the first task is still running.

FIG. 2 is a flow chart showing the step of determining the displaying status of the external display device in the image output method according to one embodiment of the present invention. As shown in FIG. 2, in another embodiment, after the step S105 for receiving the selection signal and before the step S111 for outputting the image to the selected external display device, the image output method of the present invention further comprises a determination process for determining a displaying status of the selected external display device. This determination process comprises, in the step S201, determining whether the external display device corresponding to the selected available external device option has displayed an image of the image frame corresponding to a fourth task. In other words, according to the status of the pins of the connection port for connecting the electronic device to the selected external display device, it is determined whether the connection port continuously transmit signals (i.e. whether the connection port is busy) so as to determine whether the selected external display device already has displayed the image of the image frame corresponding to another task.

When the external display device corresponding to the selected available external device option has displayed the image of the image frame corresponding to the fourth task, the electronic device stops outputting the image of the image frame corresponding to the fourth task to the external display device. Then, the step S111 for outputting the image of the image frame corresponding to the first task to the selected external display device is performed. Alternatively, when the selected external display device does not display any other image of the image frame corresponding to the other task, the step S111 for outputting the image of the image frame corresponding to the first task to the selected external display device is performed.

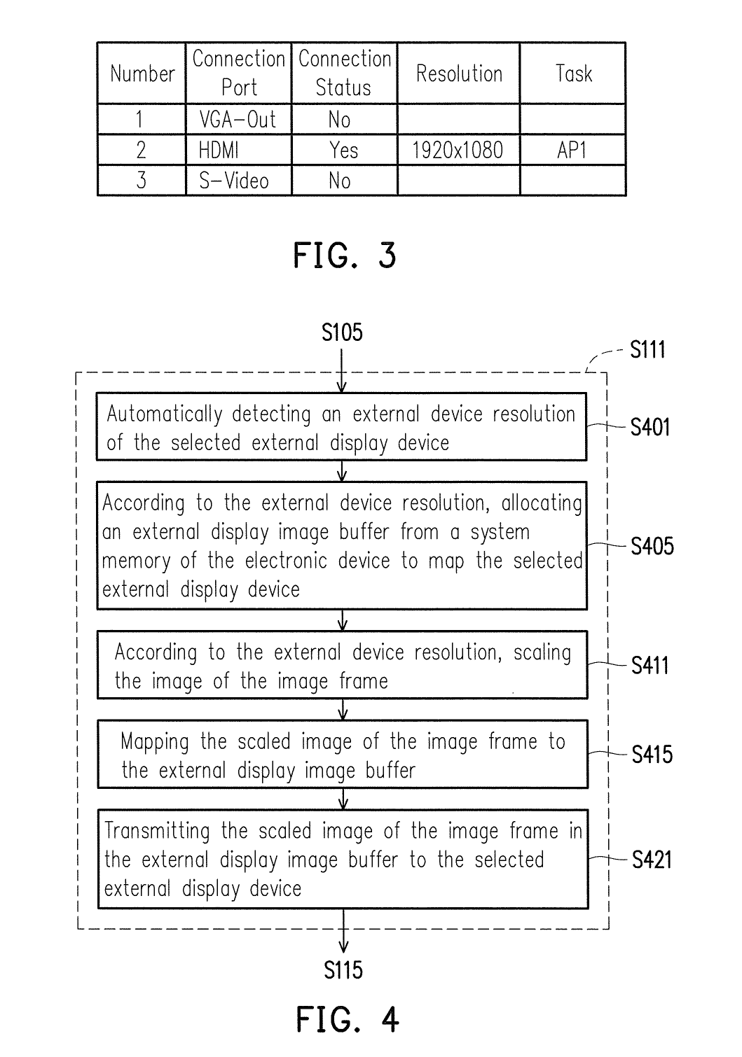

In another embodiment, as shown in FIG. 1, the image output method of the present embodiment further comprises recording a task-connection port relationship between the first task and the connection port for outputting the image of the image frame corresponding to the first task to the selected external display device (the step S121). FIG. 3 is a task-connection port relationship table according to one embodiment of the present invention. As shown in FIG. 3, in the present embodiment, the electronic device comprises three connection ports including a VGA-Out connection port which is labeled number 1, an HDMI connection port which is labeled number 2 and an S-Video connection port which is labeled number 3. According to the marks in the field of connection status, the electronic device is connected to the external display device (such as a television) through the HDMI connection port labeled number 2 and the resolution of the external display device is 1080p. Further, the electronic device outputs the image of the image frame corresponding to the task API to the external display device.

Furthermore, as shown in FIG. 1, after the step S111, the image outputted from the electronic device is displayed on the selected external display device (the step S115).

FIG. 4 is a flow chart showing the step of outputting an image to the external display device in the image output method according to one embodiment of the present invention. As shown in FIG. 4, in the present embodiment, the sub-steps of the step of outputting an image of one of the image frames displayed on the display unit (i.e. the image of the specific image frame) to the external display device corresponding to the selected available external device option (the step S111) in the image output method of the present invention are illustrated. In the step S401, an external device resolution of the selected external display device. In the step S405, according to the external device resolution, an external display image buffer from a system memory of the electronic device is allocated to map the selected external display device. Then, in the step S411, according to the external device resolution, the image of the image frame is scaled. It should be noticed that the step of scaling the image of the image frame is performed in the background of the electronic device. That is, at the time the image of the image frame corresponding to the first task is scaled, the image frame corresponding to the first task and displayed on the display unit is not affected to be shrank or enlarged by the image scaling process. In addition, the step of scaling the image of the image frame comprises scaling the image to be a full-screen image.

Thereafter, in the step S415, the scaled image of the image frame is mapped to the external display image buffer. Then, in the step S421, the scaled image of the image frame in the external display image buffer is transmitted to the external display device corresponding to the selected available external device option. Moreover, before the step S421 for transmitting the scaled image in the external display image buffer to the selected external display device, it further comprises setting a set of parameters of the external display device corresponding to the selected available external device option. In the present embodiment, since the outputted image is scaled according to the external device resolution in advance and then the scaled image is mapped to the external display image buffer which is allocated according to the external device resolution. Thereafter, the image of the image frame is continuously outputted to the external display image buffer so as to continuously update the outputted image on the external display image buffer. Hence, the images displayed on the external display device are the images mapped to the external display image buffer. Therefore, image displayed on the external display device neither is affected by the magnification or reduction of the image frame corresponding to the first task and displayed on the display unit of the near end electronic device nor is affected by the switching of the displayed image frames.

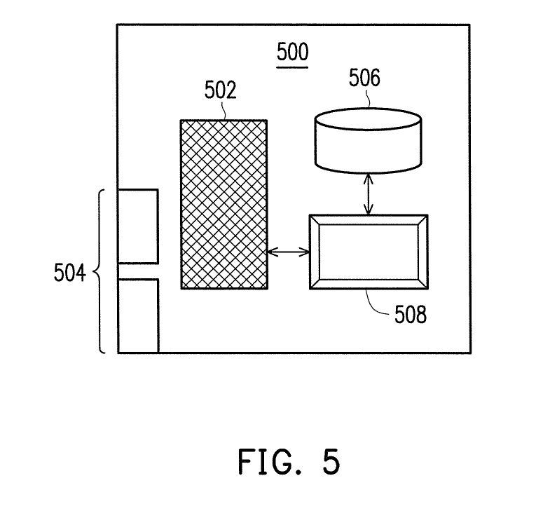

In addition, the image output method in the aforementioned embodiment can be implemented by executing a computer readable and writable program on an electronic device. FIG. 5 is a schematic diagram showing an electronic device according to one embodiment of the present invention. As shown in FIG. 5, in the present embodiment, an electronic device 500 comprises a display unit 502, at least one connection port 504, a storage device 506 and a central processing unit 508. The storage device 506 stores a computer readable and writable program. The central processing unit 508 is coupled to the display unit 502, the connection ports 504 and the storage device 506 and executes a plurality of instructions of the computer readable and writable program. These instructions comprise displaying at least one available external device option, selecting one of the available external device options and outputting an image of one of at least one image frame displayed on the display unit to the external display device corresponding to the selected available external device option (the steps S101 through S115 in the aforementioned embodiment). The aforementioned instructions further comprises, at the time the first task continuously runs, the image of the image frame corresponding to the first task is displayed on the external display device and is not affected by the electronic device launching a second task (as shown the description in the previous embodiment) or at the time the first task continuously runs, the image of the image frame corresponding to the first task is displayed on the external display device and is not affected by the display unit of the electronic device being switched to show the image frame corresponding to a third task from showing the image frame corresponding to the first task (as shown the description in the previous embodiment). These instructions further comprises the steps of determining whether the selected external display device has already displayed images of the image frame corresponding to the other task (as shown in the steps S201 through S205 in the aforementioned embodiment) and the steps of allocating the external display image buffer from the system memory of the electronic device according to the external device resolution so as to output the image to the external display device (as shown in the steps S401 through S421 in the previous embodiment). The steps of the image output method of the present invention are detailed in the previous embodiments and are not described herein.

Altogether, in the present invention, the electronic device launches the image output program embedded in a specific image frame to execute the image output method of the present invention so as to output the image of the specific image frame. Since the external device options are embedded in the tool list of the image frame at the time the image output program embedded in the specific image frame is launched, only the image of the single image frame can be outputted by executing the image output program of the specific image frame no matter the image frame is displayed by executing what kind of task. That is, not all of the frame shown by the display unit is outputted. Thus, the user can only output the image of the image frame which the user is willing to output or share with others so as to achieve the efficiency for protecting the individual privacy. Moreover, the user can open a plurality of image frames at the same time and only output image of the selected image frame. Therefore, at the time the image of the single image frame is outputted, the electronic device can also executes other tasks to improve the utilization efficiency.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An image output method for an electronic device having a display unit and at least one connection port, the image output method comprising:
the display unit displaying at least an available external device option, wherein each of the available external device options respectively corresponds to an external display device connected to the electronic device through the corresponding connection port;
receiving a selection signal to select one of the available external device options;
outputting an image of one of at least an image frame displayed on the display unit to the external display device corresponding to the selected available external device option, wherein when a first task corresponding to the output image is continuously executed either in a background or in a foreground of the electronic device, the image is continuously outputted to the external display device corresponding to the selected available external device option; and
displaying the image outputted from the electronic device on the external display device.

2. The image output method of claim 1, further comprising:
when the electronic device opens a second task to show the image frame corresponding to the second task on the display unit and the electronic device continuously executes the first task, the electronic device continuously outputting the image of the image frame corresponding to the first task to the external display device corresponding to the selected available external device option.

3. The image output method of claim 1, further comprising:
When the display unit is switched to show the image frame corresponding to a third task from showing the image frame corresponding to the first task and the electronic device continuously executes the first task, the electronic device continuously outputs the image of the image frame corresponding to the first task to the external display device corresponding to the selected available external device option.

4. The image output method of claim 1, further comprising recording a task-connection port relationship between the first task and the connection port for outputting the image of the image frame corresponding to the first task to the external display device corresponding to the selected available external device option.

5. The image output method of claim 1, wherein the step of outputting the image of one of the image frames displayed on the display unit to the external display device corresponding to the selected available external device option comprises:
automatically detecting an external device resolution of the external display device corresponding to the selected available external device option;
according to the external device resolution, allocating an external display image buffer from a system memory of the electronic device to map the external display device corresponding to the selected available external device option;
according to the external device resolution, scaling the image of the image frame;
mapping the scaled image of the image frame to the external display image buffer; and
transmitting the scaled image of the image frame in the external display image buffer to the external display device corresponding to the selected available external device option.

6. The image output method of claim 5, wherein the step of scaling the image of the image frame is executed at the background of the electronic device.

7. The image output method of claim 5, wherein the step of scaling the image of the image frame comprises scaling the image to be a full-screen image.

8. The image output method of claim 5, before the step of transmitting the scaled image of the image frame in the external display image buffer to the external display device corresponding to the selected available external device option, further comprising setting a set of parameters of the external display device corresponding to the selected available external device option.

9. The image output method of claim 1, after the step of receiving the selection signal and before the step of outputting the image to the external display device corresponding to the selected available external device option, further comprising:
determining whether the external display device corresponding to the selected available external device option has displayed the image of the image frame corresponding to a fourth task; and
when the external display device corresponding to the selected available external device option has displayed the image of the image frame corresponding to the fourth task, stopping outputting the image of the image frame corresponding to the fourth task to the external display device corresponding to the selected available external device option.

10. The image output method of claim 1, before the display unit displays the available external device options, further comprising detecting the connection ports of the electronic device to determine a connection status of the electronic device connecting to at least one of the external display devices, wherein the display unit displays the available external device options according to the connection status.

11. An electronic device, comprising:
a display unit;
at least a connection port;
a storage device storing a computer readable and writable program;
a central processing unit coupled to the display unit, the connection ports and the storage device, and executing a plurality of instructions of the computer readable and writable program, wherein the instructions comprises:
displaying at least an available external device option on the display unit, wherein each of the available external device options respectively corresponds an external display device connected to the electronic device through the corresponding connection port;
receiving a selection signal to select one of the available external device options;
outputting an image of one of at least an image frame displayed on the display unit to the external display device corresponding to the selected available external device option, wherein when a first task corresponding to the output image is continuously executed either in a background or in a foreground of the electronic device, the image is continuously outputted to the external display device corresponding to the selected available external device option; and
displaying the image outputted from the electronic device on the external display device.

12. The electronic device of claim 11, wherein the instructions further comprise:
opening a second task to show the image frame corresponding to the second task on the display unit while the first task corresponding to the outputted image is continuously executed; and
continuously outputting the image of the image frame corresponding to the first task to the external display device corresponding to the selected available device option.

13. The electronic device of claim 11, wherein the instructions further comprises:
the display unit switching to show the image frame corresponding to a third task from showing the image frame corresponding to the first task while the first task corresponding to the outputted image is continuously executed; and
continuously outputting the image of the image frame corresponding to the first task to the external display device corresponding to the selected available device option.

14. The electronic device of claim 11, wherein the instructions further comprises:
recording a task-connection port relationship between the first task and the connection port for outputting the image of the image frame corresponding to the first task to the external display device corresponding to the selected available external device option; and
storing the task-connection port relationship in the storage device.

15. The electronic device of claim 11, further comprising a system memory, wherein the instruction of outputting the image of one of the image frames displayed on the display unit to the external display device corresponding to the selected available external device option comprises:
automatically detecting an external device resolution of the external display device corresponding to the selected available external device option;
according to the external device resolution, allocating an external display image buffer from a system memory of the electronic device to map the external display device corresponding to the selected available external device option;
according to the external device resolution, scaling the image of the image frame;
mapping the scaled image of the image frame to the external display image buffer; and
transmitting the scaled image of the image frame in the external display image buffer to the external display device corresponding to the selected available external device option.

16. The electronic device of claim 15, wherein the instruction of scaling the image of the image frame is executed at the background of the electronic device.

17. The electronic device of claim 15, wherein the image of the image frame is scaled to be a full-screen image.

18. The electronic device of claim 15, wherein, before the instruction of transmitting the scaled image of the image frame in the external display image buffer to the external display device corresponding to the selected available external device option, the instructions further comprise setting a set of parameters of the external display device corresponding to the selected available external device option.

19. The electronic device of claim 11, wherein, after the instruction of receiving the selection signal and before the instruction of outputting the image to the external display device corresponding to the selected available external device option, the instructions further comprises:
determining whether the external display device corresponding to the selected available external device option has displayed the image of the image frame corresponding to a fourth task; and
when the external display device corresponding to the selected available external device option has displayed the image of the image frame corresponding to the fourth task, stopping outputting the image of the image frame corresponding to the fourth task to the external display device corresponding to the selected available external device option.

20. The electronic device of claim 11, wherein before the display unit displays the available external device options, the instructions further comprise detecting the connection ports of the electronic device to determine a connection status of the electronic device connecting to at least one of the external display devices, and the display unit displays the available external device options according to the connection status.
